(19) United States
(12) Patent Application Publication
(10) Pub. No.: US 2013/0283947 A1
(43) Pub. Date: Oct. 31, 2013

(54) LINEAR ACTUATOR

(71) Applicants: Hiroyuki Yamada, Hitachinaka (JP); Isao Hayase, Tsuchiura (JP)

(72) Inventors: Hiroyuki Yamada, Hitachinaka (JP); Isao Hayase, Tsuchiura (JP)

(73) Assignee: HITACHI, LTD., Tokyo (JP)

(21) Appl. No.: 13/991,988

(22) PCT Filed: Dec. 9, 2010
(86) PCT No.: PCT/JP2010/072134

§ 371 Date: Jul. 2, 2013

(51) Int. Cl. F16H 25/20

(52) U.S. Cl. CPC F16H 25/20
USPC 74/89.23

(57) ABSTRACT

A linear actuator includes an output rod having a flange portion on an outer peripheral surface thereof, an intermediate rod connected to a nut and having a flange portion on an outer peripheral surface thereof, a cage for housing therein coaxially the output rod and the intermediate rod and having a flange portion on an inner peripheral surface thereof at a position between the flange portion and the flange portion, a lid member disposed on a side of the output rod in the cage, a lid member disposed on a side of the intermediate rod in the cage, a coned disc spring housed between the flange portion and the flange portion, and a coned disc spring housed between the flange portion and the lid member.

### TECHNICAL FIELD

The present invention relates to a linear actuator including a screw-thread mechanism.

### BACKGROUND ART

Linear actuators including a screw-thread mechanism formed of a threaded shaft and a nut threadedly engaging the threaded shaft (e.g., ball-screw feed mechanisms) have found their applications in fields requiring high speed and high accuracy. Meanwhile, hydraulically-driven linear actuators (e.g., hydraulic cylinders) have been widely used in fields requiring a large thrust force. This was because of difficulty with which to achieve a large thrust force with the screw-thread mechanism. The recent technological progress has, however, resulted in the development of a screw-thread mechanism for large thrust force applications and electrically-driven linear actuators have come to find their applications in the fields in which hydraulic pressure was mainly used. Advantages gained by the application of electric drive include greater efficiency compared with the hydraulic drive, ease of using regenerative energy, and greater controllability and the hydraulic drive is being replaced by the electric drive.

The attempt to change a conventional product including the hydraulic drive to one including the electric drive, however, at times reveals as big problems various conditions that were not such big problems with the hydraulic drive. One of these problems is an impact load arising from, for example, vibrations and collision. With the hydraulic cylinder, the impact load is lessened by contraction and extension properties of the hydraulic cylinder. The linear actuator including the screw-thread mechanism, however, has desirably stiffness as high as possible in order to prevent controllability as one of its advantages from being impaired. As a result, the impact load cannot be sufficiently lessened, which can result in a damaged mechanical part. The situation may, however, vary from one applied product to another. Assume, for example, the impact load in a case in which the linear actuator including the screw-thread mechanism is used in place of a hydraulic cylinder applied to driving a front work implement of a hydraulic excavator. Such an impact load acts both in a direction in which the threaded shaft of the linear actuator contracts (e.g., when the bucket collides with the ground or the like during excavation) and a direction in which the threaded shaft of the linear actuator extends (e.g., when the bucket binds during a scooping up stroke). This necessitates lessening of the impact load in both directions.

As a technique for improving such impact resistance, a known ballscrew includes a threaded shaft, a nut threadedly engaging the threaded shaft, adjusting nuts threadedly engaging both ends of the nut, a movable plate (movable member) fixed to an outer periphery of the nut and movable axially along the threaded shaft, and coned disc springs, each being inserted between a corresponding one of the adjusting nuts and the movable plate. This ballscrew lessens an impact load applied to the movable plate from either axial direction of the threaded shaft using the coned disc spring that absorbs the impact load.

### PRIOR ART DOCUMENT

### Patent Document

### Patent Document 1

JP-63-251144-A

### SUMMARY OF THE INVENTION

### Problem to be Solved by the Invention

The above-described technique allows the impact load acting in both axial directions of the threaded shaft to be lessened. In the technique, the two coned disc springs are disposed so as to sandwich the movable plate from both ends in the axial direction. When preload is applied to the movable plate from both axial directions with the two coned disc springs held in a deflected condition, therefore, the preload in one direction is canceled by that in the other direction. Thus, the linearity of load transmission path that the coned disc spring is not deflected (the movable plate is not moved) by a load equal to, or less than, the preload applied thereto cannot be achieved. This makes it difficult to control the position of the movable plate (table) when the impact load acts, with the result that controllability may be degraded.

The above patent document further discloses a ballscrew that absorbs an impact load applied from one direction only in the axial direction of a threaded shaft. This ballscrew includes an adjusting nut threadedly engaging an end portion on a first side in an axial direction of a nut, a movable plate fixed to an outer periphery of the nut and movable axially along the threaded shaft, and a coned disc spring inserted between the adjusting nut and the movable plate. From a standpoint of achieving improved controllability of the movable plate by achieving the linearity of load transmission path, preload slightly smaller than a permissible load of the ballscrew is applied to the coned disc spring of the ballscrew, so that the coned disc spring is not designed to be deflected by the load equal to, or less than, the preload. This ballscrew can, however, lessen the impact load applied from one direction only in the axial direction of the threaded shaft.

Thus, it is difficult for the technique disclosed in the above-described patent document to satisfy the two requirements of lessening the impact load from both axial directions of the threaded shaft and achieving controllability. It is therefore an object of the present invention to provide a linear actuator that can solve the foregoing two problems.

### Means for Solving the Problem

To achieve the foregoing object, an aspect of the present invention provides a linear actuator including a threaded shaft and a nut threadedly engaging the threaded shaft, the linear actuator rotating the threaded shaft and the nut relatively about an axis to thereby produce axial displacement of the threaded shaft, the linear actuator comprising: when either one of a drive shaft of a drive source for rotatably driving the threaded shaft or the nut and an output member for outputting the axial displacement of the threaded shaft is a first member and either one of the threaded shaft and the nut is a second member, a first elastic element and a second elastic element that are deflected in an axial direction or a circumferential direction relative to the threaded shaft; and a supporting mechanism for supporting the first member and the second member via the first elastic element and the second elastic element, wherein the first elastic element is held in a deflected condition and is further deflected only when the first member moves relative to the supporting mechanism in a first direction in directions in which the first elastic element and the second elastic element are deflected, and the second elastic element is held in a deflected condition and is further deflected only when the second member moves relative to the supporting mechanism in a second direction in the directions in which the first elastic element and the second elastic element are deflected.

### Effects of the Invention

Even with impact loads acting in both axial directions of the threaded shaft, the present invention allows the impact loads to be lessened and achieves controllability of the linear actuator.

### BRIEF DESCRIPTION OF THE DRAWINGS

FIG. 1 is a general configuration diagram showing a linear actuator according to a first embodiment of the present invention.

FIG. 2 is an exploded view showing components that constitute an impact lessening mechanism 1 according to the first embodiment of the present invention.

FIG. 3 is an axial cross-sectional view showing the impact lessening mechanism 1.

FIG. 4 is a graph showing a deflection property of the impact lessening mechanism 1 in a condition in which preload is not applied to coned disc springs 31, 32.

FIG. 5 is a graph showing a deflection property of the impact lessening mechanism 1 in a condition in which preload is applied to the coned disc springs 31, 32.

FIG. 6 is a general configuration diagram showing a linear actuator according to a second embodiment of the present invention.

FIG. 7 is an exploded view showing components that constitute an impact lessening mechanism 10 according to the second embodiment of the present invention.

FIG. 8 is an illustration showing arrangements of a torsion mechanism 100 in the impact lessening mechanism 10.

FIG. 9 is an exploded view showing a rod 103 and a preloading member 105 in the torsion mechanism 100 and a rocking member 104 in a supporting mechanism 2.

FIG. 10 is an illustration showing an electric excavator in which the linear actuator according to the first embodiment of the present invention is applied to a hydraulic cylinder section of a hydraulic excavator.

### MODES FOR CARRYING OUT THE INVENTION

Embodiments of the present invention will be described below with reference to the accompanying drawings.

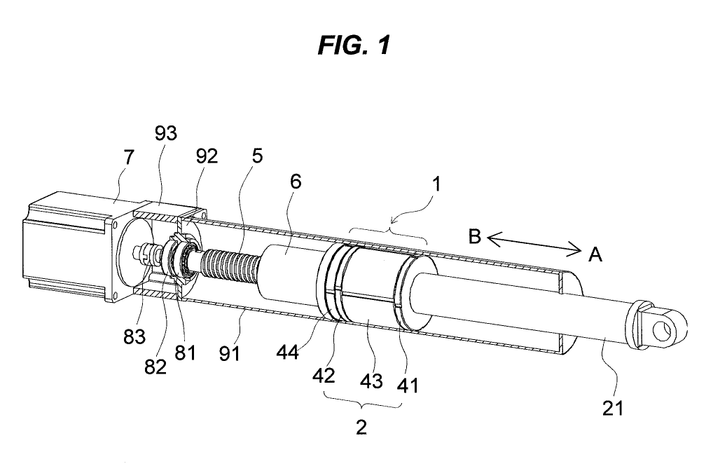

FIG. 1 is a general configuration diagram showing a linear actuator according to a first embodiment of the present invention. The linear actuator shown in this figure mainly includes a threaded shaft 5, a nut 6 threadedly engaging the threaded shaft 5, a motor (drive unit) 7 as a driver source for rotatably driving the threaded shaft 5, an impact lessening mechanism 1, and an output rod (output member) 21 fixed via the impact lessening mechanism 1 in a manner of being incapable of rotating relative to the nut 6. The threaded shaft 5 is rotatably driven by the motor 7, so that the threaded shaft 5 and the nut 6 are rotated relatively about an axis. This results in axial displacement of the nut 6 being output via the output member 21.

The threaded shaft 5 is supported rotatably about the axis and immovably in the axial direction within a cylindrical cover (cylinder tube) 91. The threaded shaft 5 has an end portion on one side (the side of the motor 7) in the axial direction supported via bearings 81, 82 by a shaft supporting member 92. The threaded shaft 5 has an end portion on the other side (the side of the output rod 21) disposed inside the output rod 21 and supported via a sliding or rolling bearing (not shown) relative to an inner surface of the output rod 21. The shaft supporting member 92 is mounted on the motor 7 via a quadrangular prism-shaped fixing member 93. The threaded shaft 5 and an output shaft of the motor 7 are connected to each other via a coupling 83. The threaded shaft 5 is rotated by driving torque of the motor 7.

The nut 6 and the impact lessening mechanism 1 are housed together with the threaded shaft 5 inside the cover 91. The output rod 21 has an end portion on a first side (the side of the motor 7) fixed unrotatably relative to the nut 6 via the impact lessening mechanism 1. The output rod 21 has an end portion on a second side protruding from the cover 91 via a substantially circular opening in an end face in the axial direction of the cover 91. The end portion on the second side of the output rod 21 is unrotatably connected to an object to be driven (not shown) of the linear actuator. This results in the impact lessening mechanism 1 and the nut 6 being connected to the output rod 21 unrotatably in a circumferential direction of the threaded shaft 5. Thus, rotating the threaded shaft 5 and the nut 6 relatively about the axis by rotatably driving the threaded shaft 5 about the axis using the driving torque of the motor 7 causes the nut 6 to be linearly moved in the axial direction of the nut 6 and the output rod 21 to be linearly moved in the axial direction via the impact lessening mechanism 1.

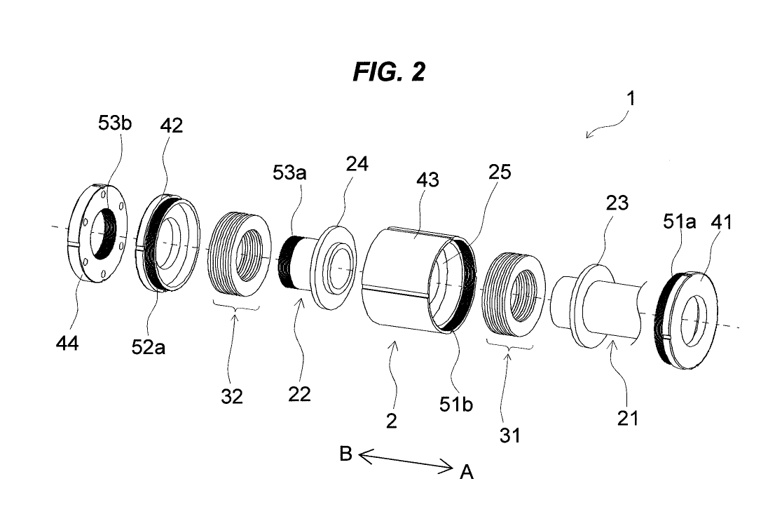

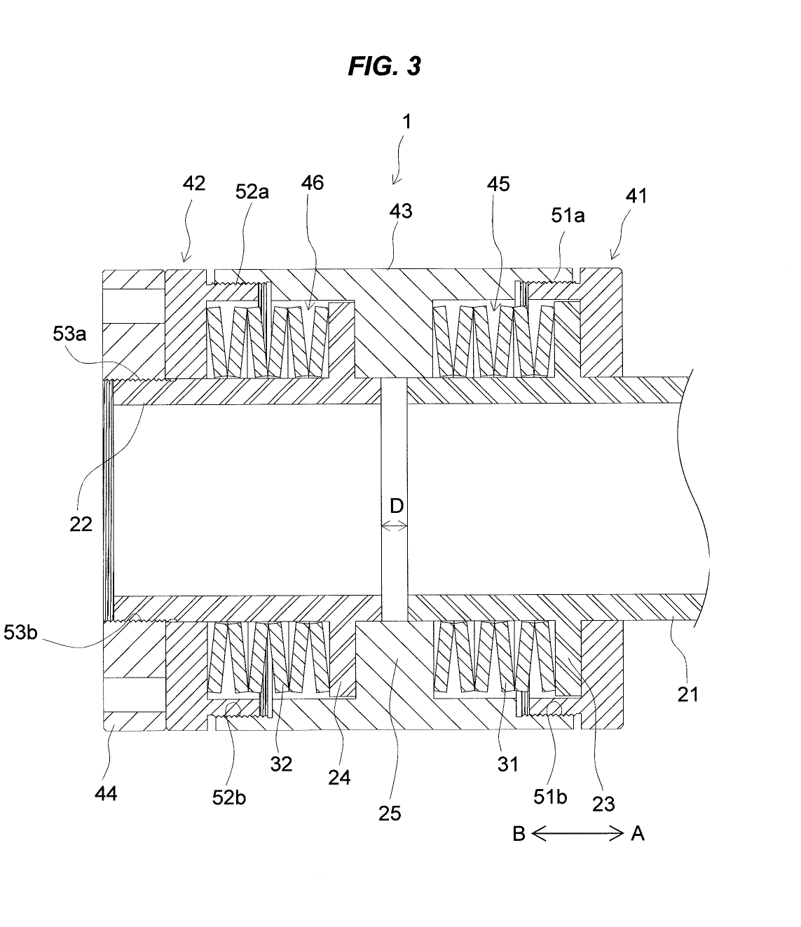

FIG. 2 is an exploded view showing components that constitute the impact lessening mechanism 1 according to the first embodiment of the present invention. FIG. 3 is an axial cross-sectional view showing the impact lessening mechanism 1. It is to be noted that like or corresponding parts are identified by the same reference numerals as those used in the figure mentioned earlier and descriptions for those parts will be omitted (the same applies to subsequent figures). The impact lessening mechanism 1 shown in these figures includes a coned disc spring 31, a coned disc spring 32, a supporting mechanism 2, an intermediate rod 22, and a fixing nut 44.

The coned disc spring 31 and the coned disc spring 32 are each a elastic element that deflects in the axial direction of the threaded shaft 5 and each have a hole at their central portions, the hole having a diameter slightly larger than outside diameters of the output rod 21 and the intermediate rod 22. It is noted that this embodiment will be described for the arrangement including the coned disc springs 31, 32; however, any other type of elastic element (e.g., a compression coil spring and a flat spring) may replace the coned disc springs 31, 32 as long as the elastic element deflects in the axial direction of the threaded shaft 5.

The supporting mechanism 2 supports the output rod 21 and the intermediate rod 22 via the coned disc spring 31 and the coned disc spring 32. The supporting mechanism 2 includes a cage 43, a lid (first lid member) 41, and a lid (second lid member) 42.

The cage 43 supports the output rod (output member) 21 and the nut 6 via the coned disc spring 31 and the coned disc spring 32. The cage 43 used in this embodiment is a substantially cylindrical member (cylindrical member). The cage 43 has a flange portion (third flange portion) 25 formed on the inside at a central portion in the axial direction of the cage 43. The output rod 21 and the intermediate rod 22 are coaxially housed inside the cage 43. As shown in the figure, in this embodiment, the output rod 21 is inserted in the cage 43 from the right-hand side in the figure of the flange portion 25 and the intermediate rod 22 is inserted in the cage 43 from the left-hand side in the figure of the flange portion 25.

The output rod 21 and the intermediate rod 22 are movably supported by the supporting mechanism 2 in the axial direction of the threaded shaft 5 independently of each other. Preferably, the threaded shaft 5 has an axial length D in the flange portion 25 such that the output rod 21 and the intermediate rod 22 are not in contact with each other even when the output rod 21 and the intermediate rod 22 are brought closest to each other in the cage 43. In addition, the output rod 21 and the intermediate rod 22 have a flange portion (first flange portion) 23 and a flange portion (second flange portion) 24, respectively, on outer peripheral surfaces thereof at their positions housed inside the cage 43 when the output rod 21 and the intermediate rod 22 are inserted in the cage 43.

The coned disc spring 31 is inserted in the output rod 21 on the left-hand side in the figure of the flange portion 23 while the lid 41 is inserted therein on the right-hand side in the figure of the flange portion 23. Specifically, the coned disc spring 31 contacts a side surface on the left-hand side in the figure of the flange portion 23 and the lid 41 contacts a side surface on the right-hand side in the figure of the flange portion 23. The coned disc spring 31 is housed in an annular spring chamber 45 formed inside the cage 43 by the flange portion 23 of the output rod 21 and the flange portion 25 of the cage 43 and in contact with the flange portion 25 of the cage 43 on the left-hand side in the figure.

An internal thread 51b is formed on the inner peripheral side at the end portion on the right-hand side in the figure of the cage 43 and an external thread 51a is formed on the outer peripheral side of the lid 41. The lid 41 is mounted, out of end portions in the axial direction of the cage 43, on an end portion on the side of the output rod 21. The lid 41 is fastened to the cage 43 by the external thread 51a being threadedly engaged with the internal thread 51b of the cage 43. To prevent the threads 51a, 51b from being loosened, preferably, the lid 41 is fixed to the cage 43 using, for example, a setscrew separately.

The lid 41 is fixed in the cage 43 so as to press the coned disc spring 31 toward the flange portion 25 via the flange portion 23. The coned disc spring 31 is thereby held in the spring chamber 45 in a condition of being deflexed in the axial direction of the threaded shaft 5 (being urged by force acting in the axial direction of the threaded shaft 5). Specifically, the coned disc spring 31 is held in a condition of being preloaded by the lid 41.

The coned disc spring 32 is inserted in the intermediate rod 22 on the left-hand side in the figure of the flange portion 24 while the lid 42 is then inserted therein on the left-hand side in the figure of the flange portion 24. Specifically, the coned disc spring 32 contacts a side surface on the left-hand side in the figure of the flange portion 24 and the flange portion 25 of the cage 43 contacts a side surface on the right-hand side in the figure of the flange portion 24. The coned disc spring 32 is housed in an annular spring chamber 46 formed inside the cage 43 by the flange portion 24 of the intermediate rod 22 and the lid 42 and in contact with the lid 42 on the left-hand side in the figure.

An internal thread 52b (see FIG. 3) is formed on the inner peripheral side at the end portion on the left-hand side in the figure of the cage 43 and an external thread 52a is formed on the outer peripheral side of the lid 42. The lid 42 is mounted, out of end portions in the axial direction of the cage 43, on an end portion on the side of the intermediate rod 22. The lid 42 is fastened to the cage 43 by the external thread 52a being threadedly engaged with the internal thread 52b of the cage 43. To prevent the threads 52a, 52b from being loosened, preferably, the lid 42 is fixed to the cage 43 using, for example, a setscrew separately.

The lid 42 is fixed in the cage 43 so as to press the coned disc spring 32 toward the flange portion 24. The coned disc spring 32 is thereby held in the spring chamber 46 in a condition of being deflexed in the axial direction of the threaded shaft 5 (being urged by force acting in the axial direction of the threaded shaft 5). Specifically, the coned disc spring 32 is held in a condition of being preloaded by the lid 42.

In a condition of the output rod 21 being urged by the coned disc spring 31, the supporting mechanism 2 assembled as described above supports the output rod 21 movably in a direction of arrow B relative to the supporting mechanism 2 and immovably in a direction of arrow A relative to the supporting mechanism 2. Similarly, in a condition of the intermediate rod 22 being urged by the coned disc spring 32, the supporting mechanism 2 supports the intermediate rod 22 movably in the direction of arrow A relative to the supporting mechanism 2 and immovably in the direction of arrow B relative to the supporting mechanism 2.

An internal thread 53b is formed on an inner peripheral side of the fixing nut 44. An external thread 53a is formed on an outer peripheral side on an end portion on the left-hand side in the figure of the intermediate rod 22. The intermediate rod 22 is inserted in, and fastened to, the fixing nut 44 by the external thread 53a being threadedly engaged with the internal thread 53b of the fixing nut 44. Though not shown in FIG. 2 or 3, the fixing nut 44 has a side surface on the left-hand side in the figure connected to the nut 6. Specifically, the nut 6 is connected to the intermediate rod 22 via the fixing nut 44. To prevent the threads 53a, 53b from being loosened, preferably, the intermediate rod 22 is fixed to the fixing nut 44 using, for example, a setscrew separately. Additionally, in this embodiment, the fixing nut 44 has its side surface on the right-hand side in the figure in contact with the lid 42. Nonetheless, the both may be in non-contact with each other.

Operation of the linear actuator having the arrangements as described above will be described below. Assume that an impact load in the direction of arrow B as a first direction in the axial direction of the threaded shaft 5 (a threaded shaft contracting direction) acts on the output rod 21. At this time, the impact load is transmitted from the flange portion 23 of the output rod 21 to the coned disc spring 31 and, from the coned disc spring 31 to the flange portion 25 of the cage 43. The impact load is further transmitted from the flange portion 25 of the cage 43 to the output rod 22 via the flange portion 24 of the output rod 22, and from the output rod 22 to the nut 6 via the fixing nut 5.

Specifically, in the linear actuator in this embodiment, the impact load acting in the direction of arrow B (the threaded shaft contracting direction) on the output rod 21 acts only on the coned disc spring 31 of the two coned disc springs 31, 32 and is further transmitted to the nut 6 via the coned disc spring 31. As a result, only when the output rod 21 is moved in the direction of arrow B (the first direction in the axial direction of the threaded shaft 5) relative to the supporting mechanism 2, if the impact load is equal to, or more than, the preload urging the coned disc spring 31, the coned disc spring 31 is deflected further from the preloaded condition to thereby lessen the impact. The foregoing may be stated differently as follows. Specifically, when the impact load acts in the direction of arrow B, the impact load (external force) acts on the coned disc spring 31 because the output rod 21 is movable in the direction of arrow B relative to the supporting mechanism 2, but no impact load (external force) acts on the coned disc spring 32 because the intermediate rod 22 is immovable in the direction of arrow B relative to the supporting mechanism 2. Thus, the linear actuator having the arrangements as described above can lessen the impact by deflecting only the coned disc spring 31, because only the coned disc spring 31 of the two coned disc springs 31, 32 is active in the impact load transmission path in the direction of arrow B.

Next, assume that an impact load in the direction of arrow A as a second direction in the axial direction of the threaded shaft 5 (a threaded shaft extending direction) acts on the output rod 21. At this time, the impact load is transmitted from the flange portion 23 of the output rod 21 to the lid 41 and from the lid 41 to the cage 43 and the lid 42. The impact load is further transmitted from the lid 42 to the coned disc spring 32, from the coned disc spring 32 to the flange portion 24 of the intermediate rod 22, and from the intermediate rod 22 to the nut 6 via the fixing nut 5.

Specifically, in the linear actuator in this embodiment, the impact load acting in the direction of arrow A (the threaded shaft extending direction) on the output rod 21 acts only on the coned disc spring 32 of the two coned disc springs 31, 32 and is further transmitted to the nut 6 via the coned disc spring 32. As a result, only when the output rod 21 is moved in the direction of arrow A (the second direction in the axial direction of the threaded shaft 5) relative to the supporting mechanism 2, if the impact load is equal to, or more than, the preload urging the coned disc spring 32, the coned disc spring 32 is deflected further from the preloaded condition to thereby lessen the impact. The foregoing may be stated differently as follows. Specifically, when the impact load acts in the direction of arrow A, the impact load (external force) acts on the coned disc spring 32 because the intermediate rod 22 is movable in the direction of arrow A relative to the supporting mechanism 2, but no impact load (external force) acts on the coned disc spring 31 because the output rod 21 is immovable in the direction of arrow A relative to the supporting mechanism 2. Thus, the linear actuator having the arrangements as described above can lessen the impact by deflecting only the coned disc spring 32, because only the coned disc spring 32 of the two coned disc springs 31, 32 is active in the impact load transmission path in the direction of arrow A.

From the foregoing, the linear actuator according to the embodiment having the arrangements as described above can lessen impact through the deflection of respective coned disc springs 31, 32 regardless of the direction in which the impact load acts on the output rod 21 in the axial direction of the threaded shaft 5 (whether in the direction of arrow A or arrow B).

Additionally, the lid 41 and the lid 42 according to the embodiment of the present invention are screwed into the cage 43 to thereby apply preload to the coned disc spring 31 and the coned disc spring 32, respectively. Such a method of preloading allows the impact lessening mechanism 1 to be handled as a rigid body under an environment in which load equal to, or less than, the preload acts, because the coned disc springs 31, 32 are not deflected under the effect of the load equal to, or less than, the preload acting thereon. As a result, if the preload to be applied is set to be a maximum load for normal use of the linear actuator (preferably slightly higher than the maximum load), the impact lessening mechanism 1 can substantially have a rigid body property under normal use and can have a spring property when an impact load larger than the load for normal use acts thereon. The foregoing will be described below with reference to relevant figures.

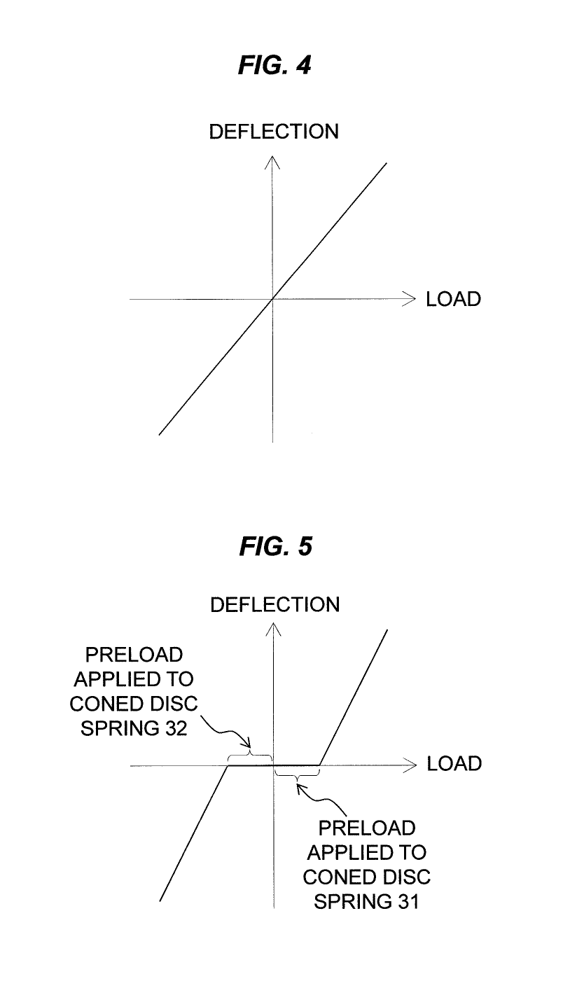

FIG. 4 is a graph showing a deflection property of the impact lessening mechanism 1 in a condition in which preload is not applied to the coned disc springs 31, 32. FIG. 5 is a graph showing a deflection property of the impact lessening mechanism 1 in a condition in which preload is applied to the coned disc springs 31, 32. In these figures, the ordinate represents deflection of the coned disc springs 31, 32 and the ordinate represents load. The impact lessening mechanism 1 is contracted in the positive direction of the deflection and extended in the negative direction of the deflection. Similarly, load contracting the impact lessening mechanism 1 acts (specifically, load acts in the direction of arrow B) in the positive direction of the load and load extending the impact lessening mechanism 1 acts (specifically, load acts in the direction of arrow A) in the negative direction of the load.

In FIG. 4, the deflection is 0 when the load is 0 and the deflection increases with the increasing load. In FIG. 5, the deflection is 0 when the load is equal to, or less than, the preload and the deflection starts as the load equal to, or more than, the preload acts. Specifically, the impact lessening mechanism 1 can be handled substantially as a rigid body while the load falls within a range in which the load is equal to, or less than, the preload and linearity of a driving force transmission path can be ensured.

Specifically, the impact lessening mechanism 1 according to the embodiment can prevent controllability from being degraded in the range of load of normal use even with the elastic elements (coned disc springs 31, 32) for lessening the impact load inserted in the driving force transmission path and lessen the impact if an impact load exceeding the range of load acts. It is noted that, in the impact lessening mechanism 1 having the arrangements as described above, preload applied to a first coned disc spring (e.g., the coned disc spring 31) does not affect preload applied to a second coned disc spring (e.g., the coned disc spring 32) and is thus independent. Preload of different magnitudes can therefore be applied to the coned disc springs 31, 32.

According to the linear actuator according to the embodiment, therefore, even if impact loads act in both directions in the axial direction of the linear actuator, the two elastic elements 31, 32 are individually deflected to thereby lessen the impact loads. In addition, by applying preload to the two elastic elements 31, 32, controllability can be ensured in the environment in which normal load equal to, or less than, the preload acts.

The above-described embodiment has been described for a case in which the threaded shaft 5 is rotatably driven by the motor 7 and the output rod 21 is connected to the nut 6 via the cage 43. The present embodiment is nonetheless applicable to a case in which a nut is rotatably driven about a threaded shaft by a drive source, such as a motor, and an output rod is connected to the threaded shaft via an impact lessening mechanism similar to the impact lessening mechanism 1 of the embodiment.

A second embodiment of the present invention will be described below. The first embodiment is intended to lessen the impact load acting on the output rod 21 in the axial direction of the threaded shaft 5 directly as the axial load. This embodiment is characterized in that the axial load is translated to a circumferential load about a threaded shaft 5 (rotational torque) via the threaded shaft 5 and a nut 6, thereby lessening the load after the translation.

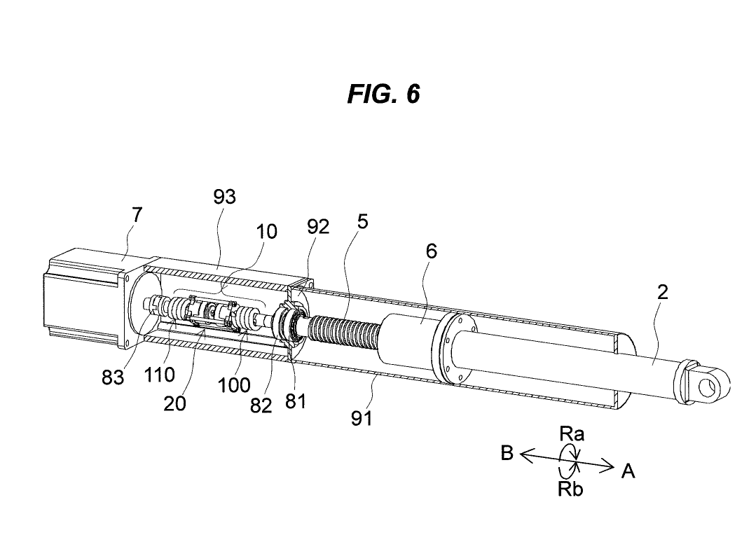

FIG. 6 is a general configuration diagram showing a linear actuator according to the second embodiment of the present invention. As shown in this figure, in this embodiment, an impact lessening mechanism 10 in place of the impact lessening mechanism 1 in the first embodiment is connected between a threaded shaft 5 and a coupling 83 and an output rod 2 is directly connected to a nut 6. The impact lessening mechanism 10 shown in this figure includes a torsion mechanism 100, a torsion mechanism 110, and a supporting mechanism 20 that coaxially supports the torsion mechanism 100 and the torsion mechanism 110. It is noted that the two torsion mechanisms 100, 110 are arranged symmetrically about columns 109. In the following, therefore, arrangements of the torsion mechanism 100 will mainly be described and arrangements of the torsion mechanism 110 may be omitted as appropriate.

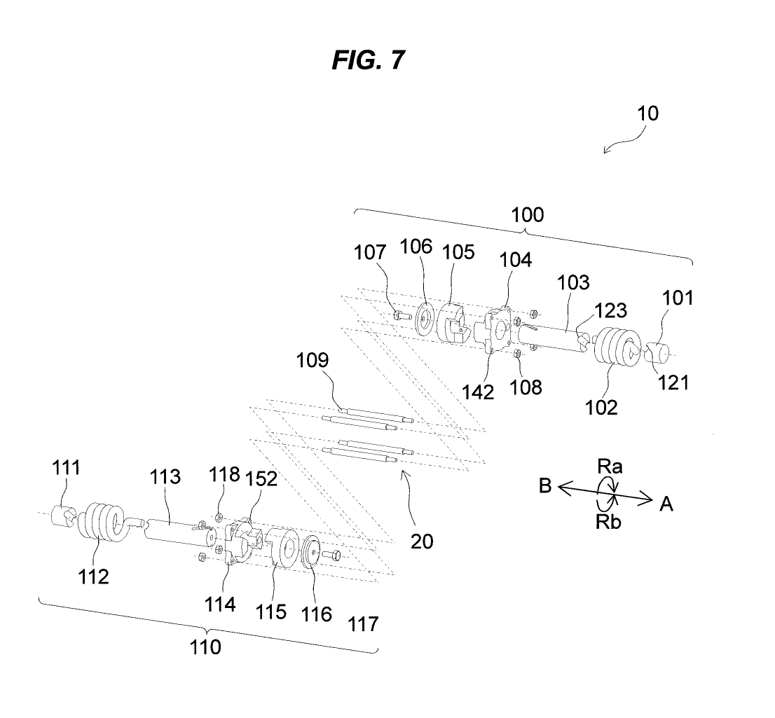

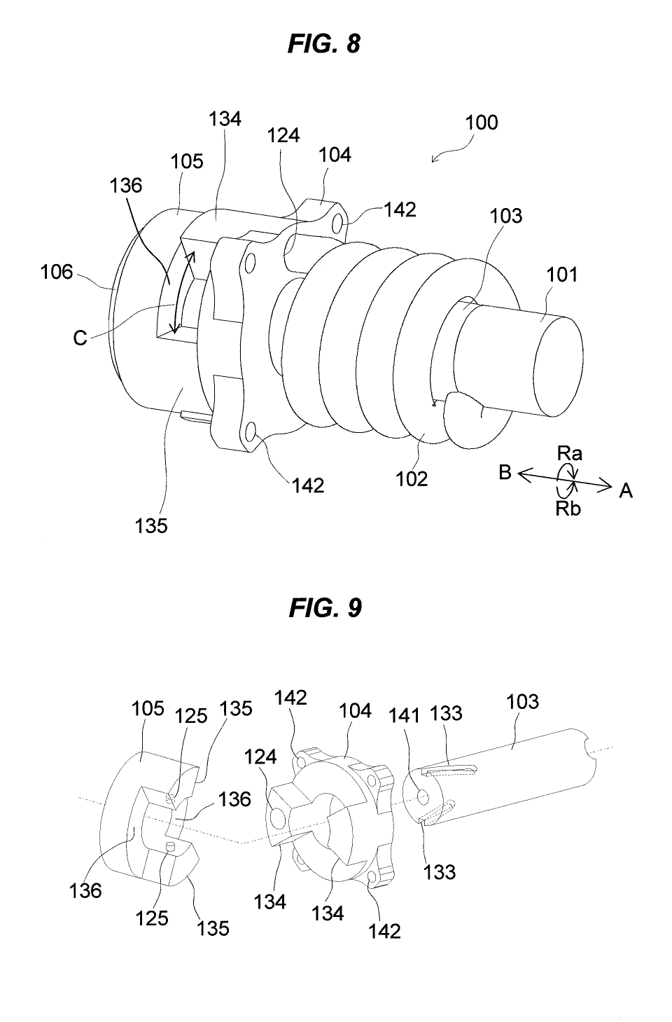

FIG. 7 is an exploded view showing components that constitute the impact lessening mechanism 10 according to the second embodiment of the present invention. FIG. 8 is an illustration showing arrangements of the torsion mechanism 100 in the impact lessening mechanism 10. FIG. 9 is an exploded view showing a rod 103 and a preloading member 105 in the torsion mechanism 100 and a rocking member 104 in the supporting mechanism 20.

In these figures, the torsion mechanism 100 includes a rod 101, a torsion spring (elastic element) 102, the rod 103, the preloading member 105, a fixing member 106, and a bolt 107. The torsion mechanism 110 includes a rod 111, a torsion spring (spring member) 112, a rod 113, a preloading member 115, a fixing member 116, and a bolt 117. The supporting mechanism 20 supports the torsion mechanism 100 and the torsion mechanism 110 via the torsion spring 102 and the torsion spring 112. The supporting mechanism 20 includes the rocking member 104, a rocking member 114, the columns 109, nuts 108, and nuts 118.

The rod 101 is disposed coaxially with the threaded shaft 5. The rod 101 has an end portion on the side of the threaded shaft 5 connected to an end portion of the threaded shaft 5. The rod 101 has the other end portion on the side of the columns 109 connected to an end portion of the rod 103 on the side of the threaded shaft 5. The rod 101 and the rod 103 have holes 121, 123, respectively, at connections thereof. The torsion spring 102 has end portions on the side of the threaded shaft 5 inserted in these holes 121, 123. Thus, the rod 101 and the rod 103 are connected in a condition of being fixed across those connections of the torsion spring 102.

The torsion spring 102 is disposed across the rod 101 and, the rod 103 and the rocking member 104 via the holes 121, 123 and a hole 124 (to be described later). The torsion spring 102 is a spring member that is deflected when rotational torque in one direction (in an Ra direction in the figure) in circumferential directions of the threaded shaft 5 acts on the rods 101, 103.

The rod 103 is disposed coaxially with the threaded shaft 5 and the rod 101 and inserted between the torsion spring 102 and, the rocking member 104 and the preloading member 105. The rod 103 has an end face on the side of the columns 109. This end face has a bolt hole 141 in which the bolt 107 is inserted. The preloading member 105 and the fixing member 106 are fixed to the end portion of the rod 103 on the side of the columns 109 via this bolt hole 141. Thus, the preloading member 105 and the fixing member 106 are integrated with the rod 103 and rotate with the rod 103 when, for example, the rotational torque acts on the rod 103 in the circumferential direction of the threaded shaft 5. A circumferential surface of the rod 103 on the side of the columns 109 has two spiral grooves 133 formed therein (see mainly FIG. 9). The two grooves 133 receive keys 125 (to be described later) of the preloading member 105. The two grooves 133 are formed at diametrically opposite positions of the rod 103.

The rocking member 104 is an annular member supported on the rod 103 rotatably in the circumferential direction of the threaded shaft 5. In addition, the rocking member 104 has the hole 124 in which the end portion of the torsion spring 102 on the side of the columns 109 is inserted, two protrusions 134 protruding toward the preloading member 105, and four holes 142 in which the columns 109 are inserted.

The two protrusions 134 are housed in recesses 136 in the preloading member 105 and disposed at diametrically opposite positions. Referring to FIG. 8, when the torsion mechanism 100 is assembled, the protrusions 134 are housed in the recesses 136 in the preloading member 105 and held in place in a condition of being in contact with protrusions 135 of the preloading member 105 in the circumferential direction of the threaded shaft 5. In addition, a clearance C (see FIG. 8) is formed at a position opposite to contact surfaces between the protrusions 134 and the protrusions 135. Through the foregoing arrangements, the supporting mechanism 20 supports the rods 101, 103 rotatably in the Ra direction relative to the supporting mechanism 20 (rocking member 104) and unrotatably in an Rb direction relative to the supporting mechanism 20 (rocking member 104) when the rods 101, 103 and the rocking member 104 are urged by the torsion spring 102. As a result, when the rods 101, 103 are rotated in the Ra direction, the preloading member 105 is rotated relative to the rocking member 104 so as to decrease the clearance C, causing a twist to be generated between the rods 101, 103 and the rocking member 104, so that the twist deflects the torsion spring 102. When the rods 101, 103 are rotated in the Rb direction, the rocking member 104 is rotated integrally with the rods 101, 103 in the corresponding direction via the contact surfaces between the protrusions 134 and the protrusions 135, so that the torsion spring 102 is not deflected.

The columns 109 are inserted in the respective holes 142 and have first end portions on the side of the threaded shaft 5 fixed to the rocking member 104 using the nuts 108. The columns 109 have second end portions inserted in respective holes 152 (see FIG. 7) in the rocking member 114 in the torsion mechanism 110 and secured to the rocking member 114 similarly using the nuts 118. This results in the rocking member 104 and the rocking member 114 being connected to each other via the four columns 109. Thus, for example, when rotational torque in one circumferential direction of the threaded shaft 5 acts, the two attempt to rotate in the same direction.

As described above, the rocking member 104 and the rod 103 in the torsion mechanism 100 are twisted only when torque acts on the rod 103 in the Ra direction, specifically, the clockwise direction as viewed from the rod 101 and are not twisted when torque acts in the counterclockwise Rb direction regardless of the magnitude of the torque. Meanwhile, the torsion mechanism 110 is arranged symmetrically with respect to the torsion mechanism 100 about the columns 109. Consequently, the rocking member 114 and the rod 113 in the torsion mechanism 110 are twisted only when the torque in the Rb direction acts on the rod 103 and not twisted when the torque in the Ra direction acts on the rod 103 regardless of the magnitude of the torque.

The preloading member 105 supports the rocking member 104 from the circumferential direction of the rod 103 so that the torsion spring 102 is held in a condition of being deflected. The preloading member 105 has the two protrusions 135 protruding toward the rocking member 104, the two keys 125 on inner peripheral surfaces of the two protrusions 135, and the two recesses 136 formed between the two protrusions in the circumferential direction.

Each of the two keys 125 protrudes inwardly in the diametric direction of the preloading member 105. The keys 125 are formed so as to fit into the grooves 133 in the rod 103. When the torsion mechanism 100 is to be assembled, the torsion spring 102 and the rocking member 104 are inserted over the rod 103 and, with the keys 125 fitted in the grooves 133, the preloading member 105 is pushed over the rod 103. This causes the preloading member 105 to be rotated in the circumferential direction (in the Rb direction) of the threaded shaft 5 along the shape of the grooves 133. Rotating the preloading member 105 in this manner causes the protrusions 135 of the preloading member 105 and the protrusions 134 of the rocking member 104 to be eventually brought into contact with each other, resulting in the rocking member 104 being rotated with the preloading member 105 in the circumferential direction of the threaded shaft 5 relative to the rod 103. When the rocking member 104 is rotated relative to the rod 103, the torsion spring 102 is deflected and thus placed in a preloaded condition. To push the preloading member 105 over the rod 103, the preloading member 105 only needs to be tightened against the rod 103 via the fixing member 106 with the bolt 107. Tightening the bolt 107 all the way relative to the rod 103 allows the preloading member 105 to be fixed to the rod 103 via the fixing member 106 and the bolt 107. This results in the torsion spring 102 being held in place in a deflected condition.

When the torsion spring 102 is deflected and preloaded as described above, a spring force (resilience) of the torsion spring 102 causes the protrusions 134 of the rocking member 104 and the protrusions 135 of the preloading member 105 to push against each other. Therefore, only when rotational torque in an opposite direction (the Ra direction) greater than the preloading torque of the torsion spring 102 acts on the rod 103, the rocking member 104 is to rotate relative to the rod 103. Specifically, when torque smaller than the preload of the torsion spring 102 acts, the rod 103 and the rocking member 104 can be handled as a rigid body. When torque greater than the preload acts, the torsion spring 102 is deflected to thereby lessen the impact. When the torque acting between the preloading member 105 and the rocking member 104 acts in the same direction as the direction of the preloading torque of the torsion spring 102 (Rb direction), the rocking member 104 rotates with the rod 103 and the preloading member 105, because the protrusions 134, 135 are in contact with each other. Thus, the rod 103 and the rocking member 104 are not twisted and can be handled as a rigid body.

In the linear actuator according to this embodiment having the arrangements as described above, assume that an impact load in the direction of arrow A as a first direction in the axial direction of the threaded shaft 5 (a threaded shaft extending direction) acts on the output rod 2 and the impact load thereby generates rotational torque in the Ra direction in the threaded shaft 5 and the rod 103 via the nut 6. At this time, the rotational torque acts to twist the rod 103 and the rocking member 104 and thus deflects the torsion spring 102. It is noted that, even if the rotational torque causes the rocking member 104 to be rotated in the Ra direction, the rotational torque in the Ra direction transmitted from the rocking member 104 to the rocking member 114 via the columns 109 is directly transmitted from the rocking member 114 to the preloading member 115 and the rod 113. Thus, the rocking member 114 rotates with the preloading member 115 and the rod 103 in the Ra direction and the torsion spring 112 is not deflected.

Specifically, the linear actuator according to this embodiment transmits the rotational torque acting in the Ra direction in which the torsion spring 102 is deflected to the torsion spring 102 without allowing the rotational torque to act on the torsion spring 112. This causes the torsion spring 102 to be deflected further from the preloaded condition to thereby lessen the impact only when the rod 103 is rotated in the Ra direction (in a first circumferential direction of the threaded shaft 5) relative to the supporting mechanism 20. The foregoing may be stated differently as follows. Specifically, when the rotational torque in the Ra direction acts on the threaded shaft 5, the rotational torque acts on the torsion spring 102 because, in the torsion mechanism 100, the rod 103 is rotatable relative to the supporting mechanism 20 (rocking member 104), but in the torsion mechanism 110, the rotational torque does not act on the torsion spring 112 because the supporting mechanism 20 (rocking member 114) rotates in the same direction as the rod 113 does. Consequently, in the impact lessening mechanism 10 having the arrangements as described above, only the torsion spring 102 out of the two torsion springs 102, 112 is active in a path transmitting the rotational torque in the Ra direction (impact load in the direction of arrow A) and the impact can be lessened by deflecting the torsion spring 102.

Assume that an impact load in the direction of arrow B as a second direction in the axial direction of the threaded shaft 5 (a threaded shaft contracting direction) acts on the output rod 2 and the impact load thereby generates rotational torque in the Rb direction in the threaded shaft 5 and the rod 103 via the nut 6. At this time, the rotational torque is directly transmitted from the rod 103 and the preloading member 105 to the rocking member 104 and transmitted via the columns 109 to the rocking member 114. The rotational torque transmitted to the rocking member 114 acts in a direction of twisting of the rod 113 and the rocking member 114, thus deflecting the torsion spring 112. It is noted that, at this time, the rocking member 104 rotates with the rod 103 and the preloading member 105 in the Rb direction and thus the torsion spring 102 is not deflected.

Specifically, the linear actuator according to this embodiment transmits the rotational torque acting in the Rb direction in which the torsion spring 112 is deflected to the torsion spring 112 without allowing the rotational torque to act on the torsion spring 102. This causes the torsion spring 112 to be deflected further from the preloaded condition to thereby lessen the impact only when the rod 113 is rotated in the Rb direction (in a second circumferential direction of the threaded shaft 5) relative to the supporting mechanism 20. The foregoing may be stated differently as follows. Specifically, when the rotational torque in the Rb direction acts on the threaded shaft 5, the rotational torque acts on the torsion spring 112 because, in the torsion mechanism 110, the supporting mechanism 20 (rocking member 114) is rotatable relative to the rod 113, but in the torsion mechanism 100, the rotational torque does not act on the torsion spring 102 because the supporting mechanism 20 (rocking member 104) rotates in the same direction as the rod 103 does. Consequently, in the impact lessening mechanism 10 having the arrangements as described above, only the torsion spring 112 out of the two torsion springs 102, 112 is active in a path transmitting the rotational torque in the Rb direction (impact load in the direction of arrow B) and the impact can be lessened by deflecting the torsion spring 112.

Thus, the linear actuator according to this embodiment having the arrangements as described above can lessen impact through the deflection of one of the torsion springs 102, 112 even with the rotational torque in either circumferential direction (in the Ra direction or the Rb direction) acting on the threaded shaft 5.

In this embodiment, too, preload can be applied to the torsion spring 102 and the torsion spring 112 independently of each other and preload of different magnitudes, for example, can be applied to the two. To change the magnitude of the preload, the spiral pitch of the spiral grooves 133 formed in the rod 103 only needs to be changed. In this case, the torsion springs 102, 112 are not deflected even when rotational torque equal to, or less than, the preload is applied. Thus, such preloading allows the impact lessening mechanism 10 to be handled as a rigid body under an environment in which the rotational torque equal to, or less than, the preload acts. Thus, if the preload to be applied is set to be a maximum load of normal use of the linear actuator (preferably slightly higher than the maximum load), the impact lessening mechanism 10 can substantially have a rigid body property under normal use and can have a spring property when an impact load larger than the load for normal use acts thereon.

Thus, in the linear actuator according to this embodiment, too, even if impact loads act in both directions in the axial direction of the linear actuator, the two elastic elements 102, 112 are individually deflected to thereby lessen the impact loads. In addition, by applying preload to the two elastic elements 102, 112, high controllability can be ensured in the environment in which impact load equal to, or less than, the preload acts.

It is noted that the above-described embodiment has been described for a case in which the threaded shaft 5 is rotatably driven by the motor 7 and the impact lessening mechanism 10 is disposed between the threaded shaft 5 and the motor 7. The embodiment nonetheless be applicable to an arrangement in which the nut is rotatably driven about the threaded shaft by a drive source, such as a motor, and the impact lessening mechanism similar to that of the above embodiment is disposed between the threaded shaft and the drive source.

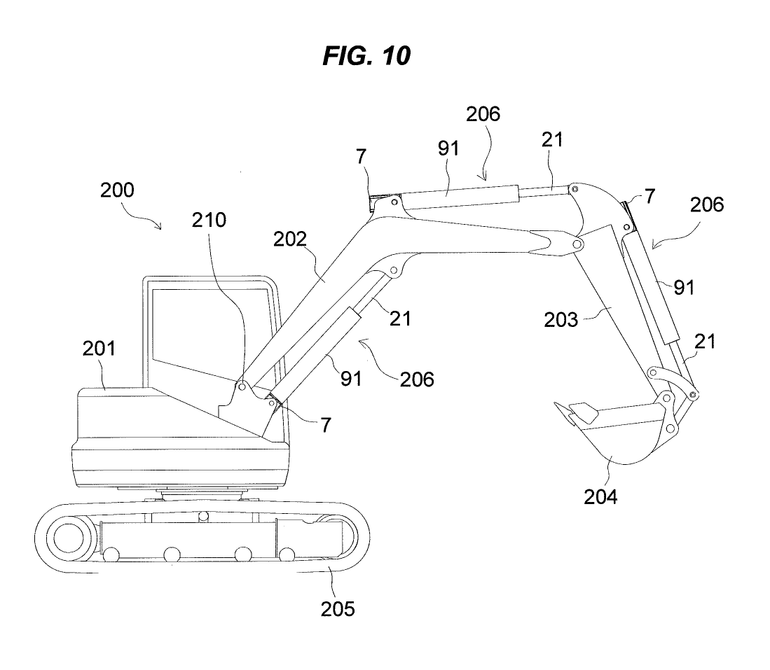

FIG. 10 is an illustration showing an electric excavator in which the linear actuator according to the first embodiment of the present invention is applied to a hydraulic cylinder section of a hydraulic excavator. The electric excavator 200 shown in this figure includes an upper swing structure 201, a work implement including a boom 202, an arm 203, and a bucket 204, a crawler (lower track structure) 205, and a plurality of linear actuators 206. The linear actuators 206 correspond to the linear actuator according to the first embodiment. The boom 202 is rotatably connected to the upper swing structure 201. The arm 203 is rotatably connected to the boom 202. The bucket 204 is rotatably connected to the arm 203.

The side of the linear actuator 206 adjacent to its motor 7 is rotatably connected to a position different from a connection 210 between the upper swing structure 201 and the boom 202. The side of the linear actuator 206 adjacent to its output rod 21 is rotatably connected to a substantially central portion of the boom 202. Thus, linearly driving the linear actuator 206 allows the boom 202 to be pivotally driven relative to the upper swing structure 201 about the connection 210.

The work implement will be briefly described. Similarly to the above, the linear actuator 206 is connected to each of the arm 203 and the bucket 204 as shown in the figure. Linearly driving each linear actuator 206 causes the arm 203 to be rotatably driven relative to the boom 202 and the bucket 204 to be rotatably driven relative to the arm 203. This constitutes the work implement (the boom, the arm, and the bucket) of the electric excavator including the linear actuators 206 according to the first embodiment as linear drive sources.

Impacts in both directions of the extending and contracting sides of the cylinder (output rod 21) act on linear driving sections that drive the work implement of the hydraulic excavator 200 having the arrangements as described above. The application of the linear actuator 206 described in the above embodiments, however, allows the impact load to be lessened even if the impacts act in the two directions. Damage on the threaded shaft 5 and the nut 6 can thereby be prevented and, in the range of load of normal use, high stiffness and high controllability can be maintained of sections from the motor output shaft to the output rod leading end. The change from the hydraulic cylinder to the linear actuator 206 improves drive efficiency, which leads to reduced energy consumption.

Here, the case in which the linear actuators 206 according to the first embodiment are applied in place of the hydraulic cylinder has been described. Understandably, the same effects can also be achieved by applying the linear actuator according to the second embodiment. Additionally, the example described above is the application of the linear actuator 206 to the hydraulic excavator. Nonetheless, the linear actuator 206 is applicable to other types of construction machinery (work machines) including forklift trucks and wheel loaders without any problem.

### DESCRIPTION OF REFERENCE NUMERALS

1 Impact lessening mechanism
2 Supporting mechanism
5 Threaded shaft
6 Nut
7 Motor (drive source)
10 Impact lessening mechanism
20 Supporting mechanism
21 Output rod
22 Intermediate rod
31, 32 Coned disc spring (elastic element)
41, 42 Lid (lid member)
43 Cage (cylindrical member)
100, 110 Torsion mechanism
101, 111 Rod
102, 112 Torsion spring
103, 113 Rod
104, 114 Rocking member
105, 115 Preloading member
106, 116 Fixing member
107, 117 Bolt
108, 118 Nut
109 Column
200 Electric excavator

1. A linear actuator including a threaded shaft and a nut threadedly engaging the threaded shaft, the linear actuator rotating the threaded shaft and the nut relatively about an axis to thereby produce axial displacement of the threaded shaft, the linear actuator comprising:
when either one of a drive shaft of a drive source, the drive source for rotatably driving the threaded shaft or the nut, and an output member for outputting the axial displacement of the threaded shaft is a first member, and when either one of the threaded shaft and the nut is a second member,
a first elastic element and a second elastic element that are deflected in an axial direction or a circumferential direction relative to the threaded shaft; and
a supporting mechanism for supporting the first member and the second member via the first elastic element and the second elastic element, wherein
the first elastic element is held in a deflected condition and is further deflected only when the first member moves relative to the supporting mechanism in a first direction in directions in which the first elastic element and the second elastic element are deflected, and
the second elastic element is held in a deflected condition and is further deflected only when the second member moves relative to the supporting mechanism in a second direction in the directions in which the first elastic element and the second elastic element are deflected.

2. A linear actuator including a threaded shaft and a nut threadedly engaging the threaded shaft, the linear actuator rotating the threaded shaft and the nut relatively about an axis to thereby produce axial displacement of the threaded shaft, the linear actuator comprising:
when either one of a drive shaft of a drive source for rotatably driving the threaded shaft or the nut and an output member for outputting the axial displacement of the threaded shaft is a first member and either one of the threaded shaft and the nut is a second member,
a supporting mechanism for supporting the first member and the second member; and
a first elastic element and a second elastic element that are deflected in an axial direction or a circumferential direction relative to the threaded shaft, wherein
the first elastic element is held in a deflected condition by the supporting mechanism and the first member and is further deflected when the first member moves relative to the supporting mechanism in the first direction in the directions in which the first elastic element and the second elastic element are deflected,
the second elastic element is held in a deflected condition by the supporting mechanism and the second member and is further deflected when the second member moves relative to the supporting mechanism in the second direction in the directions in which the first elastic element and the second elastic element are deflected, and
the supporting mechanism supports the first member movably relative to the supporting mechanism in a first direction in directions in which the first elastic element and the second elastic element are deflected and supports the second member movably relative to the supporting mechanism in a second direction in the directions in which the first elastic element and the second elastic element are deflected.

3. A linear actuator including a threaded shaft and a nut threadedly engaging the threaded shaft, the linear actuator rotating the threaded shaft and the nut relatively about an axis to thereby produce axial displacement of the threaded shaft, the linear actuator comprising:
a first rod having a first flange portion on an outer peripheral surface thereof, the first rod outputting axial displacement of the threaded shaft;
a second rod connected to the threaded shaft or the nut, the second rod having a second flange portion on an outer peripheral surface thereof;
a cylindrical member for housing therein coaxially the first rod and the second rod, the cylindrical member having a third flange portion on an inner peripheral surface thereof at a position between the first flange portion and the second flange portion;
a first lid member disposed at an end portion in an axial direction of the cylindrical member on a side of the first rod;
a second lid member disposed at an end portion in the axial direction of the cylindrical member on a side of the second rod;
a first elastic element housed between the first flange portion and the third flange portion; and
a second elastic element housed between the second flange portion and the second lid member, wherein
the first lid member is fixed to the cylindrical member so as to press the first elastic element toward the third flange portion via the first flange portion, and
the second lid member is fixed to the cylindrical member so as to press the second elastic element toward the second flange portion.

4. A linear actuator including a threaded shaft and a nut threadedly engaging the threaded shaft, the linear actuator rotating the threaded shaft and the nut relatively about an axis to thereby produce axial displacement of the threaded shaft, the linear actuator comprising:
a first rod connected to a drive shaft of a drive source;
a second rod connected to the threaded shaft or the nut;
a first rocking member for rotatably supporting the first rod;
a second rocking member connected to the first rocking member, the second rocking member rotatably supporting the second rod;
a first torsion spring disposed across the first rod and the first rocking member, the first torsion spring being deflected by rotational torque that allows the first rod to rotate relative to the first rocking member in a first circumferential direction of the threaded shaft;
a second torsion spring disposed across the second rod and the second rocking member, the second torsion spring being deflected by rotational torque that allows the second rod to rotate relative to the second rocking member in a second circumferential direction of the threaded shaft;
a first preloading member fixed to the first rod, the first preloading member supporting the first rocking member from a circumferential direction of the first rod so that the first torsion spring is held in a deflected condition; and
a second preloading member fixed to the second rod, the second preloading member supporting the second rocking member from a circumferential direction of the second rod so that the second torsion spring is held in a deflected condition.

5. A construction machine comprising the linear actuator according to claim 1.

6. A construction machine comprising the linear actuator according to claim 2.

7. A construction machine comprising the linear actuator according to claim 3.

8. A construction machine comprising the linear actuator according to claim 4.
